(19) United States
(12) Patent Application Publication
(10) Pub. No.: US 2026/0233690 A1
(43) Pub. Date: Aug. 13, 2026

(54) SYSTEMS AND METHODS FOR PROVIDING SIGNALS TO AN EXTERNAL VEHICLE ACCESSORY

(71) Applicant: Ford Global Technologies, LLC, Dearborn, MI (US)

(72) Inventors: Eduardo Velez, Estado de Mexico (MX); Alejandra Hernandez, Cuautitlan Izcalli (MX); Erick Rodriguez, Naucalpan de Juarez (MX)

(73) Assignee: Ford Global Technologies, LLC, Dearborn, MI (US)

(21) Appl. No.: 19/048,218

(22) Filed: Feb. 7, 2025

(51) Int. Cl. B60R 16/023; B60W 50/08

(52) U.S. Cl. CPC B60R 16/023; B60W 50/08

(57) ABSTRACT

A vehicle including a plurality of electronic control units (ECUs), an electronic controller and a signal provider device is disclosed. The ECUs may output a plurality of signals to the electronic controller. The electronic controller may obtain user inputs indicative of user selection of one or more signals of interest from the plurality of signals, and may output the signals of interest to the signal provider device based on the user inputs. The signal provider device may connect with an aftermarket external vehicle accessory and may transmit the signals of interest to the external vehicle accessory to enable the accessory's operation.

### FIELD

The present disclosure relates to systems and methods for providing signals indicative of vehicle operational parameters to an aftermarket vehicle accessory installed in a vehicle.

### BACKGROUND

Many users customize their vehicles with aftermarket car accessories, gadgets, attachments, etc. to modify the vehicle's visual appeal and/or the vehicle's performance or comfort. For example, many users install Light Emitting Diode (LED) bars or beams, fog lights, additional headlights, dash cameras, external GPS devices, steering wheel sensors for speed or torque, and/or the like to their vehicles to modify the vehicle's visual appeal and/or performance.

Connecting such aftermarket accessories to a vehicle can be complex and/or tedious. For example, in many cases, a mechanic is needed to disassemble one or more vehicle components to access the vehicle's wire harness and then electrically connect the aftermarket accessory to one or more wires in the harness.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a view of an example vehicle including a plurality of custom signal provider devices in accordance with the present disclosure.

FIG. 2 depicts a schematic diagram of example connections between vehicle components in accordance with the present disclosure.

FIG. 3 depicts a block diagram of a plurality of vehicle components in accordance with the present disclosure.

FIG. 4 depicts a flow diagram of an example method for providing vehicle signals to an aftermarket vehicle accessory in accordance with the present disclosure.

### DETAILED DESCRIPTION

### Overview

The present disclosure describes a custom signal provider device (or “CSP”) that may enable an operator or a mechanic to conveniently connect one or more aftermarket vehicle accessories to a vehicle. The CSP may be part of the vehicle and may include a plurality of electrical ports through which the operator may connect an external accessory to the vehicle. By using the CSP, the operator may not be required to disassemble one or more vehicle components to access the vehicle's wire harness and then one-by-one select and connect those wires to the accessory that provide the required vehicle signals to the accessory (which is the conventional method of connecting an aftermarket accessory to a vehicle). Instead, by using the CSP, the operator may just connect the accessory to the CSP's electrical ports to enable the accessory's operation (without having to individually select and connect any wires).

In addition to the CSP(s), the vehicle may include an electronic controller, a plurality of electronic control units (ECUs) and a vehicle Human-Machine Interface (HMI). The ECUs may provide/output a plurality of vehicle signals to the electronic controller. The vehicle signals may be indicative of a plurality of operational parameters associated with the vehicle, such as parameters associated with a vehicle door open or closed state, a vehicle parking light illumination state, a vehicle interior light illumination state, a vehicle rear light illumination state, a vehicle turn light illumination state, a vehicle reverse motion light illumination state, a vehicle camera activation state, a vehicle ignition state, a vehicle speed reduction rate, and/or the like.

As may be appreciated, an aftermarket accessory may require one or more vehicle signals (referred to as “signals of interest”), from the plurality of vehicle signals described above, to operate optimally. For example, an aftermarket hood light strip may require vehicle signals indicative of vehicle parking state, daytime running light and/or vehicle ignition ON state to illuminate in an optimal manner. Similarly, an aftermarket light emitting diode (LED) bar may require vehicle signals indicative of a vehicle speed reduction rate, a car turn state, a rear light, a parking light and/or vehicle ignition ON state to illuminate in an optimal manner.

The operator may “configure” or select, via the HMI, the signals of interest (from the plurality of vehicle signals described above) that may be transmitted to a CSP, based on an aftermarket accessory that may be connected to the CSP. For example, if the aftermarket hood light strip is connected to the CSP, the operator may select the vehicle signals indicative of vehicle parking state, daytime running light and/or vehicle ignition ON state, as the signals of interest to be transmitted to the CSP, which may further transmit these signals to the hood light strip to enable its operation.

Responsive to the operator configuring the CSP and connecting it to the accessory, the electronic controller may obtain the user inputs (indicative of the selected signals of interest) from the HMI and the plurality of vehicle signals from the ECUs. The electronic controller may further correlate the user inputs and the plurality of vehicle signals, to select and transmit the signals of interest to the CSP. The CSP may further transmit the signals of interest to the connected accessory via the CSP's electrical ports, to enable the accessory's operation. In this manner, by simply connecting the accessory to the CSP's electrical ports and by selecting the signals of interest on the HMI, the operator may connect the accessory to the vehicle and enable its operation, without having to access the vehicle's wire harness and individually selecting and connecting the wires to the accessory.

The vehicle may further include one or more circuit protection components that may enhance the operation of the CSP(s) and the connected aftermarket accessories. For example, the vehicle may include a surge suppressor that may protect the accessories connected to the CSPs from voltage spikes and a fuse that may protect the accessories from overloads and short circuits.

The present disclosure discloses a custom signal provider device that may enable the operator to conveniently connect/install a plurality of aftermarket accessories to the vehicle, without having to unnecessarily disassemble one or more vehicle components to access the vehicle's wire harness. The CSP considerably reduces the operator's manual effort to install the accessories in the vehicle and makes the installation process simple, less time-consuming, and less prone to human error.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

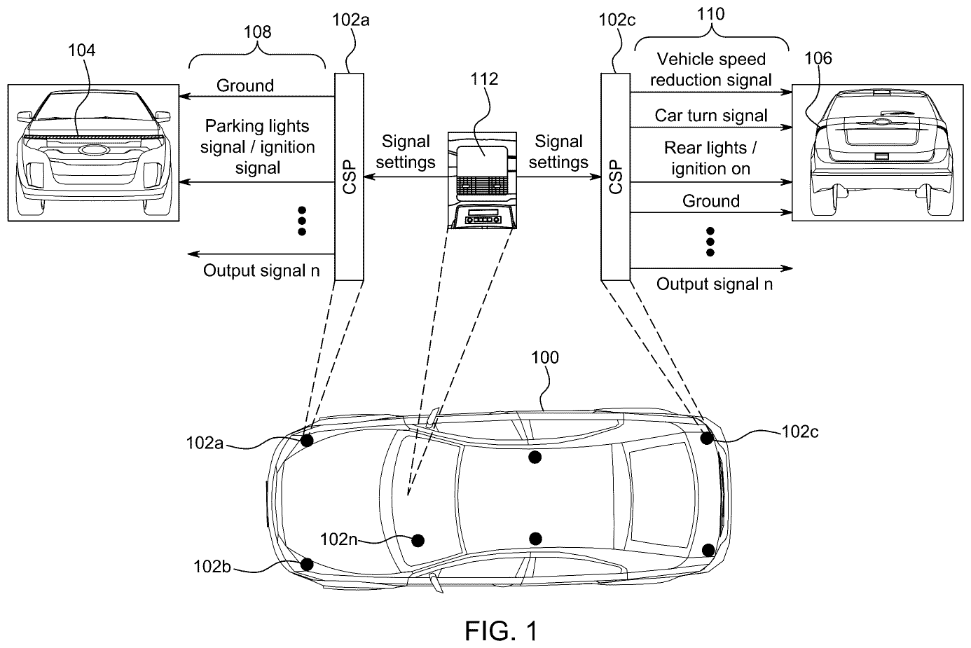

FIG. 1 depicts a view of an example vehicle 100 including a plurality of custom signal provider devices 102a, 102b, 102c, 102n (collectively referred to as CSPs 102) in accordance with the present disclosure. The vehicle 100 may take the form of any passenger or commercial vehicle, for example, a car, a work vehicle, a crossover vehicle, a truck, a van, a minivan, a taxi, a bus, etc. The vehicle 100 may be a manually driven vehicle and/or may be configured to operate in a partially or fully autonomous mode and may include any powertrain such as a gasoline engine, one or more electrically-actuated motor(s), a hybrid system, etc.

The CSPs 102 may enable an operator or a mechanic (not shown) to conveniently connect one or more aftermarket external vehicle accessories to the vehicle 100. For example, the CSPs 102 may enable the operator to conveniently connect a hood light strip 104, an aftermarket Light Emitting Diode (LED) bar 106 in proximity to a vehicle rear light, steering wheel sensor indicators, additional display screens (over and above existing vehicle display screens), additional interior and/or exterior lights, LED beams, fog lights, dash cameras, external GPS units, additional biometric authentication devices, and/or the like, to the vehicle 100.

It may be appreciated that such aftermarket accessories require one or more vehicle signals indicative of vehicle operational parameters to function in an optimal manner. For example, the hood light strip 104 may require one or more vehicle signals (e.g., Controller Area Network or CAN signals) indicative of vehicle parking state, daytime running light and/or vehicle ignition ON state to illuminate in an optimal manner and at the right time. The hood light strip 104 may also require direct current or ground signal to operate in an optimal manner. These signals are collectively depicted as signals 108 in FIG. 1. As another example, the LED bar 106 may require one or more vehicle signals indicative of a vehicle speed reduction rate, a car turn state, a rear light, a parking light and/or vehicle ignition ON state to illuminate in an optimal manner and at the right time. The LED bar 106 may also require the direct current or ground signal to operate in an optimal manner. These signals are collectively depicted as signals 110 in FIG. 1.

Conventionally, to install such aftermarket accessories in the vehicle 100, the operator would be required to disassemble one or more vehicle components to access the vehicle's wire harness and then one-by-one select and connect those wires to the respective accessories that provide the required vehicle signals. For example, to install the LED bar 106 in the vehicle 100, the operator would be required to select and connect (one-by-one) those wires from the harness to the LED bar 106 that provide signals indicative of the vehicle speed reduction rate, the car turn state, the rear light, the parking light and/or the vehicle ignition ON state. This method of accessory connection is complex, tedious, time-consuming and prone to human error.

To enable the operator to conveniently connect the aftermarket accessories to the vehicle 100 without having to manually select and connect the wires from the vehicle's wire harness to the accessories, the present disclosure discloses the CSPs 102 that may be installed/disposed at a plurality of different locations in the vehicle 100. The CSPs 102 may connect with respective accessories and output one or more vehicle signals to the respective accessories, which the operator may select or “pre-configure” via a vehicle Human-Machine Interface (HMI) 112 or a user device (not shown).

The CSPs 102 may be part of the vehicle 100 and may be installed at a plurality of locations in the vehicle 100 where the probability of installation of aftermarket external vehicle accessories is high. In the exemplary aspect depicted in FIG. 1, the CSPs 102 (or their connection ports that connect with the accessories) are shown to be located in proximity to vehicle's front and rear lights, front sitting areas, and driver's dashboard. It may be appreciated that by placing the CSPs 102 (or their connection ports) in proximity to the vehicle's lights allows for easy customization features, enabling the vehicle user to personalize (as per the user's preference) the vehicle's appearance and functionality with widgets that can react in synchronization with the lights. Further, by installing the CSPs 102 (or their connection ports) in proximity to the front sitting areas provides the user with the opportunity to add personalized features, such as enhanced comfort controls, multimedia devices, or other accessory integrations that allow the vehicle 100 to be adapted to any special needs of the driver or the passenger. Furthermore, it may be appreciated that the dashboard is an important area for customization as it is a focal point for driver's interaction. By installing the CSPs 102 (or their connection ports) at the dashboard, the user may integrate advanced technology solutions, such as heads-up displays or custom instrumentation, to adapt the user's driving experience to personal preferences or needs.

It is to be noted that the CSPs 102 are not configured to receive input signals from any external device (e.g., biometric authentication devices, custom instrumentation, etc.) that may negatively affect the vehicle's operation and/or the occupant's wellbeing. The CSPs 102 are configured to receive signals from in-car ECUs, as described later in the description below.

The example CSP locations depicted in FIG. 1 should not be construed as limiting. The vehicle 100 may include a plurality of additional CSPs at different locations, without departing from the present disclosure scope.

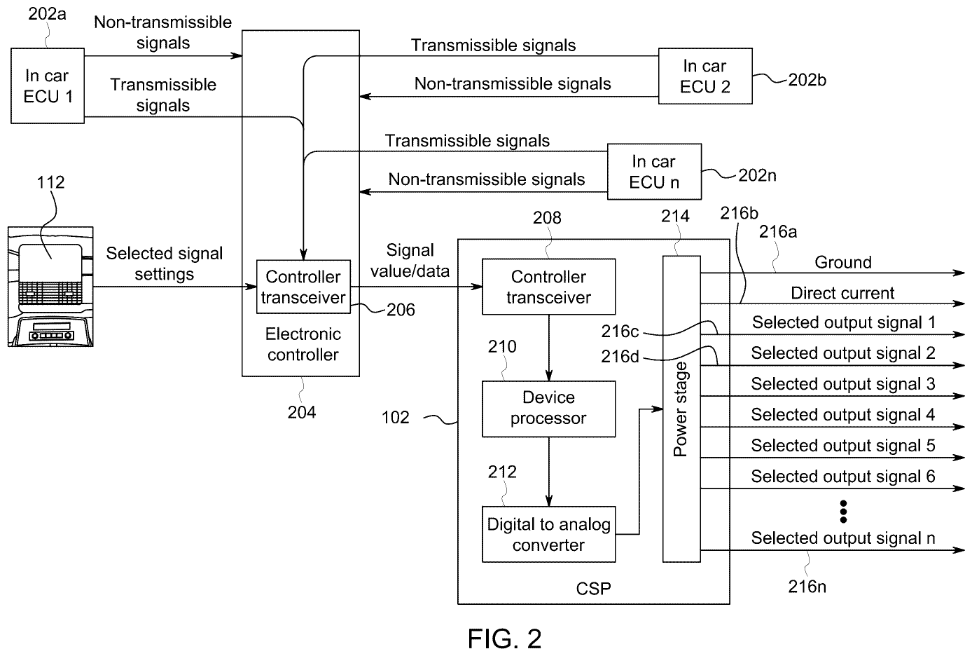

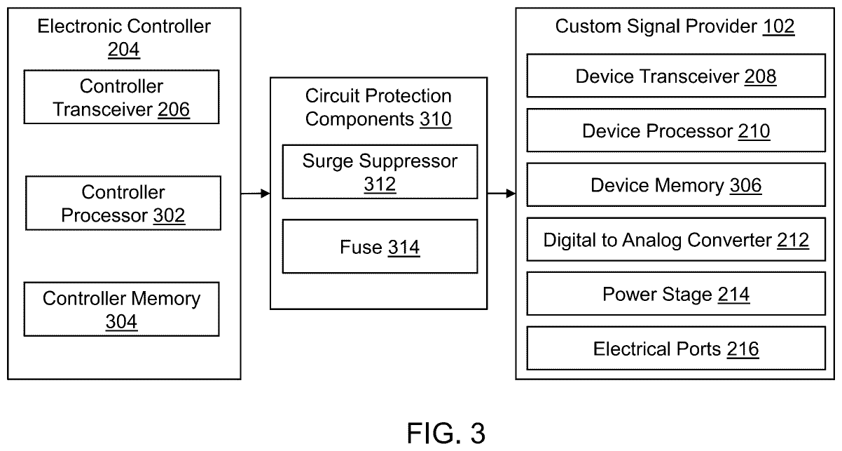

In an exemplary aspect, while installing an aftermarket accessory (e.g., the LED bar 106) in the vehicle 100, the operator may connect the LED bar 106 to a CSP (e.g., the CSP 102c) via one or more electrical connection ports (shown as electrical ports 216 in FIGS. 2 and 3) of the CSP 102c. In this process, the operator may not be required to disassemble one or more vehicle components to access the vehicle's wire harness and then select and connect respective wires one-by-one to the LED bar 106 to make the connection. Instead, in this case, the operator may just connect the LED bar 106 to the CSP's electrical connection ports (without having to individually select and connect any wires).

The operator may further access the HMI 112 (or the user device communicatively coupled with the vehicle 100) to “configure” the CSP 102c for the LED bar 106. Specifically, at this step, the operator may select one or more vehicle signals of interest (from a plurality of vehicle signals indicative of a plurality of vehicle operational parameters) that the vehicle 100 should transmit to the CSP 102c, which may further transmit the signals to the LED bar 106 to enable its operation/function. For example, in this case, the operator may select those vehicle signals via the HMI 112 that are indicative of the vehicle speed reduction rate, the car turn state, the rear light, the parking light and/or the vehicle ignition ON state, to be transmitted to the CSP 102c, which may further transmit these signals to the LED bar 106 to enable its operation.

Responsive to the operator making such selection on the HMI 112, the vehicle 100 may transmit the selected vehicle signals to the CSP 102c (and may not transmit other vehicle signals to the CSP 102c that are not selected by the operator), which may further transmit these signals to the LED bar 106. In some aspects, while configuring the CSP 102c, the operator may select which vehicle signal should be transmitted/output from which electrical connection port of the CSP 102c, to enable accurate and efficient electrical connection between the CSP 102c and the LED bar 106.

A CSP 102 may have a predefined count of electrical connection ports and may hence transmit a predefined count of vehicle signals to one or more accessories connected to the CSP 102. Further, the operator may configure each CSP 102 separately via the HMI 112, so that each accessory may be optimally connected to the respective CSP. For example, in a similar manner as described above, the operator may configure the CSP 102a for the hood light strip 104, to enable its installation and operation without having to manually select and connect one or more vehicle wires to the hood light strip 104.

It may be appreciated from the description above that the CSPs 102 enable the operator to conveniently connect/install a plurality of aftermarket accessories to the vehicle 100, without having to unnecessarily disassemble one or more vehicle components to access the vehicle's wire harness. The CSPs 102 considerably reduce the operator's manual effort to install the accessories in the vehicle 100 and make the installation process simple, less time-consuming, and less prone to human error.

Further vehicle and CSP details are described below in conjunction with FIGS. 2 and 3.

The vehicle 100 and the operator implement and/or perform operations, as described here in the present disclosure, in accordance with the owner manual and safety guidelines. In addition, any action taken by the operator or the vehicle user should comply with all the rules specific to the location and operation of the vehicle 100 (e.g., Federal, state, country, city, etc.). The notifications/recommendations, as provided by the vehicle 100, should be treated as suggestions and only followed according to any rules specific to the location and operation of the vehicle 100.

FIG. 2 depicts a schematic diagram 200 of example connections between vehicle components in accordance with the present disclosure. Specifically, the diagram 200 depicts connections between a plurality of in-car electronic control units (ECUs) 202a, 202b, 202n (collectively referred to as ECUs 202), an electronic controller 204, the CSP 102 and the HMI 112. The ECUs 202, the electronic controller 204, the CSP 102 and the HMI 112 may be part of the vehicle 100 and may be electrically and/or communicatively connected/coupled with each other via wired and/or wireless connection. FIG. 2 will be described in conjunction with FIG. 3.

The ECUs 202 may be connected to or associated with a plurality of vehicle components (not shown), e.g., vehicle lights, sensors such as ambient light sensors, sitting area sensors, proximity sensors, cameras, etc., vehicle ignition, vehicle control unit, and/or the like. The ECUs 202 may output a plurality of signals (e.g., CAN signals) that may be associated with or indicative of a plurality of vehicle operating parameters. For example, the ECUs 202 may output signals indicative of vehicle parameters associated with a vehicle door open or closed state, a vehicle parking light illumination state, a vehicle interior light illumination state, a vehicle rear light illumination state, a vehicle turn light illumination state, a vehicle reverse motion light illumination state, a vehicle camera activation state, a vehicle ignition state, a vehicle speed reduction rate, and/or the like. The signals output by the ECUs 202 may have data related to the functionality of multiple vehicle components (e.g., vehicle lights, cameras, engine, etc.) or operational parameters, e.g., data indicating when a vehicle door is open, lights are ON or in automatic mode, if the vehicle 100 is in park or in motion, etc.

The electronic controller 204 may obtain the plurality of signals from the ECUs 202. The electronic controller 204 may further obtain operator or user inputs indicative of user selection of one or more signals of interest (from the plurality of signals) that the operator may desire to transmit to the CSP 102. For example, if the CSP 102 is connected with the LED bar 106, the operator may select the signals indicative of the vehicle speed reduction rate, the car turn state, the rear light, the parking light and/or the vehicle ignition ON state as the signals of interest, to be transmitted to the CSP 102 to enable the LED bar's operation, as described above in conjunction with FIG. 1.

In some aspects, the electronic controller 204 may obtain the user inputs indicative of user selection of the signals of interest via the HMI 112 (as shown in FIG. 2) or a user device associated with the operator or the vehicle owner. In an exemplary aspect, the electronic controller 204 may obtain the user inputs after the vehicle 100 authenticates the operator (to prevent the misuse of the CSP 102 and/or any other vehicle component). The vehicle 100 may authenticate the operator via facial recognition, fingerprint recognition, authentication codes, and/or by using any other conventional authentication methods.

In an exemplary aspect, the ECUs 202 may output one or more “transmissible” signals and one or more “non-transmissible” signals to the electronic controller 204, as shown in FIG. 2. The transmissible signals may be those vehicle signals that may be allowed (e.g., by the vehicle manufacturer) to be transmitted to the CSPs 102, and the non-transmissible signals may be those vehicle signals that may not be allowed to be transmitted to the CSPs 102. In some aspects, when the operator accesses the HMI 112 (or the user device) to select the signals of interest to be transmitted to the CSP 102, the operator may be able to view only the list of transmissible signals and may not be able to view the list of non-transmissible signals. Consequently, the operator may be able to select the signals of interest to be transmitted to the CSP 102 only from the list of transmissible signals that are output from the ECUs 202.

Furthermore, the electronic controller 204 may include a controller transceiver 206 that may receive all the transmissible signals output from the ECUs 202 and may not receive the non-transmissible signals. The controller transceiver 206 may further receive the user inputs indicative of the user selection of signals of interest from the HMI 112 (or the user device). In some aspects, the electronic controller 204 may further include a controller processor 302 (shown in FIG. 3) that may receive the user inputs and the transmissible signals from the controller transceiver 206 and may correlate or compare the user inputs with the transmissible signals (specifically the data included in the transmissible signals). Based on the correlation, the controller processor 302 may select (from all the transmissible signals obtained by the controller processor 302) and output the signals of interest to the CSP 102, via the controller transceiver 206, as shown in FIG. 2. Specifically, the controller processor 302 may output signal values/data associated with the signals of interest to the CSP 102, via the controller transceiver 206. In some aspects, the controller transceiver 206 may output/transmit the signals of interest to the CSP 102 via CAN or via any other communication protocol.

The electronic controller 204 may further include a controller memory 304. The controller processor 302 may be disposed in communication with one or more memory devices disposed in communication with the respective computing systems (e.g., the controller memory 304 and/or one or more external databases not shown in FIG. 2). The controller processor 302 may utilize the controller memory 304 to store programs in code and/or to store data for performing aspects in accordance with the disclosure. The controller memory 304 may be a non-transitory computer-readable storage medium or memory storing program codes that may enable the controller processor 302 to perform operations as per the present disclosure. The controller memory 304 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

As described above, the signal values/data associated with the signals of interest output by the controller transceiver 206 are obtained by the CSP 102. In some aspects, the CSP 102 may include a plurality of components including, but not limited to, a device transceiver 208, a device processor 210, a digital-to-analog converter 212, a power stage unit 214 (or power stage 214), a plurality of electrical connection ports 216a, 216b, 216c, 216d, 216n (collectively referred to as electrical ports 216) and a device memory 306 (which may be similar to the controller memory 304). The device transceiver 208 may receive the signals of interest (specifically, the signal values/data associated with the signals of interest) from the electronic controller 204/controller transceiver 206. In this manner, the CSP 102 may obtain the signals of interest from the electronic controller 204 via the device transceiver 208.

The device processor 210 (which may be similar to the controller processor 302) may receive the signals of interest from the device transceiver 208 and may transmit the received signals to the digital-to-analog converter 212. The digital-to-analog converter 212 may transform the received signals of interest (which may be in digital form) to analog signals and transmit the analog signals to the power stage 214. The power stage 214 may include or be electrically connected with the electrical ports 216 and may transmit the analog signals in the required format (e.g., as 12 Volt/1 Ampere signals) to the electrical ports 216 selected or configured by the operator.

The operator may connect the aftermarket external accessory (e.g., the LED bar 106) to the CSP 102 via the electrical ports 216. The electrical ports 216 may transfer the signals of interest (specifically the analog signals associated with the signals of interest obtained from the power stage 214/digital-to-analog converter 212) to the LED bar 106 to enable its operation. In this manner, the CSP 102 provides the signals of interest to the aftermarket accessory, based on the signals selected by the operator on the HMI 112. In some aspects, the CSP 102/power stage 214 may further transmit, via the electrical ports 216, a direct current signal and/or a ground signal to the aftermarket accessory to enable its optimal operation.

In some aspects, not all the signals output from the CSP 102 have to be used for only one purpose (i.e., for only one aftermarket accessory). If the CSP 102 is disposed in a vehicle location that provides more output signals than the count of signals an aftermarket accessory may need, the other signals output by the CSP 102 may be used in different applications or for different purposes. For example, as shown in the example depiction of FIG. 1, not all the signals output from the CSPs 102a, 102c are used by or fed to the hood light strip 104 and the LED bar 106.

The vehicle 100 may include one or more additional components that may enhance the operation of the CSPs 102 and the connected aftermarket accessories. For example, the vehicle 100 may include one or more circuit protection components 310, which may include components such as a surge suppressor 312, a fuse 314, and/or the like. The surge suppressor 312 may protect the external vehicle accessories connected to the CSPs 102 from voltage spikes, and the fuse 314 may protect the external vehicle accessories from overloads and short circuits. In some aspects, the circuit protection components 310 may be part of the vehicle 100 and may be located/connected at different locations in the circuitry depicted in the diagram 200 of FIG. 2 (e.g., in the circuitry connecting the electronic controller 204 with the CSP 102). In other aspects, the circuit protection components 310 may be part of the CSPs 102.

In further aspects, the vehicle 100 may perform a plurality to steps to ensure the CSPs 102 operate in an optimal manner. For example, the vehicle 100 may update/upgrade the software associated with the electronic controller 204 regularly to ensure optimal operation. The vehicle 100 may further disable unnecessary services and change default credentials, provide strong authentication and permissions management to prevent the misuse of vehicle components and/or the accessories, implement data encryption techniques to protect the vehicle data during signal transmission, keep the CSPs 102 and/or the electronic controller 204 (collectively referred to as “devices”) on a separate network different from the main vehicle network to minimize the probability of unauthorized access, take backup of vehicle data, and/or the like. The vehicle 100 may further ensure that all the devices are properly grounded to prevent static charge buildup and electric shock, use shielded cables for signal transmission to reduce electromagnetic interference that can affect the device operation, and keep the devices away from sources of electromagnetic interference such as electric motors and radio frequency equipment. Additionally, the vehicle 100 may use UPS (Uninterruptible Power Supply) to protect the devices against power interruptions and provide backup power in case of power interruptions, keep the devices in an environment with controlled temperature and humidity conditions to prevent condensation and corrosion, and use sealed enclosures to protect the devices from dust and moisture.

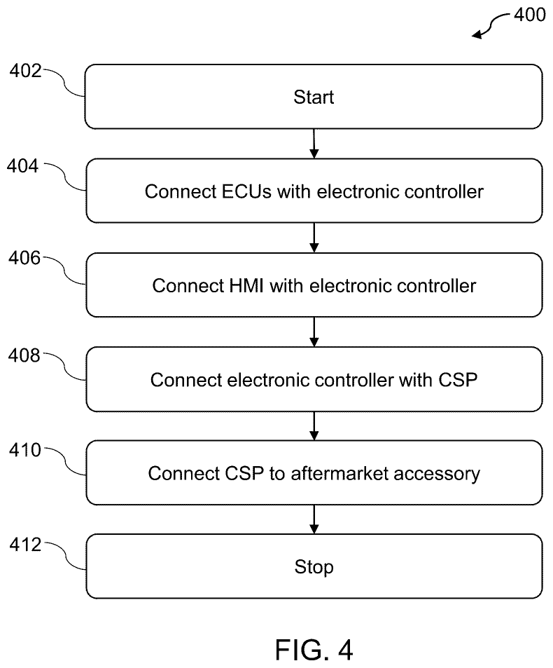

FIG. 4 depicts a flow diagram of an example method 400 for providing vehicle signals to an aftermarket vehicle accessory in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include connecting the ECUs 202 with the electronic controller 204, so that the electronic controller 204 may obtain the plurality of vehicle signals from the ECUs 202. At step 406, the method 400 may include connecting the HMI 112 with the electronic controller 204. At step 408, the method 400 may include connecting the electronic controller 204 with the CSP 102. As described above, the CSP 102 may receive the signals of interest from the electronic controller 204, which the operator selects from the plurality of vehicle signals via the HMI 112.

At step 410, the method 400 may include connecting the CSP 102 with the aftermarket external accessory. As described above, the CSP 102 may transmit the signals of interest obtained from the electronic controller 204 to the aftermarket external accessory to enable its operation, after the aftermarket external accessory is connected with the CSP 102. The method 400 may end at step 412.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a plurality of electronic control units (ECUs) configured to output a plurality of signals;
an electronic controller configured to:
obtain the plurality of signals from the plurality of ECUs;
obtain user inputs indicative of user selection of one or more signals of interest from the plurality of signals; and
output the one or more signals based on the user inputs; and
a signal provider device configured to:
connect with an external vehicle accessory;
obtain the one or more signals from the electronic controller; and
transmit the one or more signals to the external vehicle accessory to enable an external vehicle accessory operation.

2. The vehicle of claim 1, wherein the electronic controller obtains the user inputs via a vehicle Human-Machine Interface (HMI) or a user device.

3. The vehicle of claim 1, wherein the plurality of signals is associated with a plurality of vehicle operational parameters.

4. The vehicle of claim 3, wherein the plurality of vehicle operational parameters comprises parameters associated with one or more of: a vehicle door open or closed state, a vehicle parking light illumination state, a vehicle interior light illumination state, a vehicle rear light illumination state, a vehicle turn light illumination state, a vehicle reverse motion light illumination state, a vehicle camera activation state, a vehicle ignition state or a vehicle speed reduction rate.

5. The vehicle of claim 1, wherein the signal provider device is further configured to transmit a direct current signal and a ground signal to the external vehicle accessory.

6. The vehicle of claim 1, wherein the signal provider device comprises:
a transceiver configured to receive the one or more signals from the electronic controller;
one or more electrical ports; and
a processor configured to obtain the one or more signals from the transceiver and transfer the one or more signals to the one or more electrical ports, wherein:
the signal provider device connects with the external vehicle accessory via the one or more electrical ports, and
the one or more electrical ports are configured to transfer the one or more signals to the external vehicle accessory to enable the external vehicle accessory operation.

7. The vehicle of claim 1, wherein the signal provider device is installed in the vehicle in proximity to a vehicle front or rear light, a front sitting area, or a driver dashboard.

8. The vehicle of claim 1 further comprising a surge suppressor to protect the external vehicle accessory from voltage spikes.

9. The vehicle of claim 1 further comprising a fuse to protect the external vehicle accessory from overloads and short circuits.

10. A signal provider device comprising:
a transceiver configured to receive one or more signals of interest from an electronic controller of a vehicle, wherein the electronic controller is configured to:
obtain a plurality of signals from a plurality of electronic control units (ECUs) of the vehicle;
obtain user inputs indicative of user selection of the one or more signals of interest from the plurality of signals; and
output the one or more signals to the transceiver;
one or more electrical ports; and
a processor configured to obtain the one or more signals from the transceiver and transfer the one or more signals to the one or more electrical ports, wherein:
the signal provider device connects with an external vehicle accessory via the one or more electrical ports, and
the one or more electrical ports are configured to transfer the one or more signals to the external vehicle accessory to enable an external vehicle accessory operation.

11. The signal provider device of claim 10, wherein the electronic controller obtains the user inputs via a vehicle Human-Machine Interface (HMI) or a user device.

12. The signal provider device of claim 10, wherein the plurality of signals is associated with a plurality of vehicle operational parameters.

13. The signal provider device of claim 12, wherein the plurality of vehicle operational parameters comprises parameters associated with one or more of: a vehicle door open or closed state, a vehicle parking light illumination state, a vehicle interior light illumination state, a vehicle rear light illumination state, a vehicle turn light illumination state, a vehicle reverse motion light illumination state, a vehicle camera activation state, a vehicle ignition state or a vehicle speed reduction rate.

14. The signal provider device of claim 10, wherein the processor is further configured to transmit a direct current signal and a ground signal to the external vehicle accessory, via the one or more electrical ports.

15. The signal provider device of claim 10, wherein the signal provider device is installed in the vehicle in proximity to a vehicle front or rear light, a front sitting area, or a driver dashboard.

16. The signal provider device of claim 10 further comprising a surge suppressor to protect the external vehicle accessory from voltage spikes.

17. The signal provider device of claim 10 further comprising a fuse to protect the external vehicle accessory from overloads and short circuits.

18. A method comprising:
connecting a plurality of electronic control units (ECUs) with an electronic controller of a vehicle, wherein the plurality of ECUs is configured to output a plurality of signals, and wherein the electronic controller is configured to:
obtain the plurality of signals from the plurality of ECUs;
obtain user inputs indicative of user selection of one or more signals of interest from the plurality of signals; and
output the one or more signals based on the user inputs; and
connecting the electronic controller with a signal provider device, wherein the signal provider device is configured to:
connect with an external vehicle accessory;
obtain the one or more signals from the electronic controller; and
transmit the one or more signals to the external vehicle accessory to enable an external vehicle accessory operation.

19. The method of claim 18, wherein the plurality of signals is associated with a plurality of vehicle operational parameters.

20. The method of claim 18, wherein the signal provider device is further configured to transmit a direct current signal and a ground signal to the external vehicle accessory.
